(19) United States
(12) Patent Application Publication
(10) Pub. No.: US 2026/0147939 A1
(43) Pub. Date: May 28, 2026

(54) METHOD AND SYSTEM FOR VERIFYING AND CERTIFYING MOBILE ARTIFICIAL INTELLIGENCE BASED ON MICRO AGENT

(71) Applicant: Piamond Corp., Busan (KR)

(72) Inventor: Doo Geon Hwang, Busan (KR)

(73) Assignee: Piamond Corp., Busan (KR)

(21) Appl. No.: 19/277,179

(22) Filed: Jul. 22, 2025

(30) Foreign Application Priority Data
Nov. 22, 2024 (KR) 10-2024-0168225
Apr. 15, 2025 (KR) 10-2025-0049037

(51) Int. Cl. G06F 21/64; G06F 21/57

(52) U.S. Cl. CPC G06F 21/64; G06F 21/577

(57) ABSTRACT

A method and system for verifying and certifying mobile AI (Artificial Intelligence) based on a micro agent includes an input layer that registers an AI model based on information submitted by a developer. A verification and certification core verifies the registered AI model through each of a plurality of micro verification engines, and integrates and cross-verifies verification results from the plurality of micro verification engines. An output layer assigns a grade to the registered AI model and issues a certificate based on a comprehensive evaluation result of the verification and certification core for the registered AI model.

### CROSS REFERENCE TO RELATED PATENT APPLICATION

This application claims the benefit of priority under 35 U.S.C. § 119 to Korean Patent Application No. 10-2024-0168225 filed on Nov. 22, 2024, and Korean Patent Application No. 10-2025-0049037 filed on Apr. 15, 2025, in the Korean Intellectual Property Office (KIPO), the entire contents of which are incorporated herein by reference.

### BACKGROUND

### 1. Field

The following embodiments relate to a method and system for verifying and certifying mobile AI (Artificial Intelligence) based on a micro agent.

### 2. Description of Related Art

Mobile AI must operate in environments with limited computing power and battery life, making optimization essential. It is difficult to run large-scale AI models and there are limitations on memory usage, so model weight reduction is necessary. In addition, the mobile AI often handles users' personal data, making security and privacy protection critical concerns.

Additionally, cloud-based AI requires network connection, which can lead to latency issues and data transmission costs. In applications requiring real-time processing, performance limitations may arise. To address these problems, technologies such as on-device AI, hardware acceleration, and model weight reduction are being actively researched.

### PRIOR ART DOCUMENTS

Korean Patent Publication No. 10-2024-0030186

### SUMMARY

Embodiments provide a method and system for verifying and certifying mobile AI (Artificial Intelligence) based on a micro agent.

A system for verifying and certifying artificial intelligence implemented by at least one computer device is provided, the system comprising: an input layer for registering an artificial intelligence model based on information submitted by a developer; a verification and certification core for verifying the registered artificial intelligence model through each of a plurality of micro verification engines, and integrating and cross-verifying verification results from the each of the plurality of micro verification engines; an output layer for assigning a grade to the registered artificial intelligence model and issuing a certificate based on comprehensive evaluation result of the verification and certification core for the registered artificial intelligence model; and a data storage for storing verification data including data generated during the verification process of the verification and certification core, history data including the verification history of the artificial intelligence model, and a knowledge base including verification criteria and reference data.

According to an aspect, the plurality of micro verification engines may be configured to comprise a first verification engine for performance verification, a second verification engine for bias verification, a third verification engine for security verification, and a fourth verification engine for stability verification.

According to another aspect, the first verification engine may be configured to measure at least one performance metric among response time, throughput, and accuracy in relation to the artificial intelligence model, to perform at least one of a stress test and a load test on the artificial intelligence model to evaluate the system's limitations, and to analyze resource utilization efficiency of the artificial intelligence model.

According to another aspect, the second verification engine may be configured to verify diversity and representativeness of dataset used for training the artificial intelligence model, and to evaluate presence of statistical bias in the artificial intelligence model by analyzing fairness with respect to protected attributes.

According to another aspect, the third verification engine may be configured to perform adversarial attack simulations on the artificial intelligence model, to examine possibility of data privacy breaches, and to evaluate resistance for model reverse engineering to analyze security vulnerabilities.

According to another aspect, the fourth verification engine may be configured to verify operations for the artificial intelligence model under boundary conditions, to evaluate its ability to handle exceptional situations, and to analyze whether performance degradation occurs during long-term operation.

According to another aspect, the verification and certification core may be configured to cross-analyze mutual verification results among the plurality of micro verification engines by coordinating execution of the plurality of micro verification engines.

According to another aspect, the verification and certification core may be configured to verify consistency among the results of the plurality of micro verification engines, to apply an arbitration logic in case of conflicting verification results to derive the result with relatively higher reliability, and to quantify the reliability of the verification results.

According to another aspect, the verification and certification core may be configured to verify consistency of the results obtained from repeated verifications performed by each of the plurality of micro verification engines, and to determine whether consistent results are derived under identical conditions by analyzing the temporal stability of the verification results.

According to another aspect, the output layer may be configured to generate at least one of improvement suggestions and recommendations for the artificial intelligence model based on the comprehensive evaluation results, and to provide the same to the developer.

According to another aspect, the input layer may be configured to verify required documents and metadata through information submitted by the developer, and to determine whether basic requirements of the artificial intelligence model are satisfied.

A method for verifying and certifying artificial intelligence of a system for verifying and certifying artificial intelligence implemented by at least one computer device is provided, the at least one computer device comprising at least one processor, and the method for verifying and certifying artificial intelligence comprising registering an artificial intelligence model based on information submitted by a developer, by the at least one processor; verifying the registered artificial intelligence model through each of a plurality of micro verification engines, by the at least one processor; integrating and cross-verifying verification results from the each of the plurality of micro verification engines, by the at least one processor; assigning a grade to the registered artificial intelligence model and issuing a certificate based on comprehensive evaluation result of the verification and certification core for the registered artificial intelligence model, by the at least one processor; and storing verification data including data generated during the verification process of the verification and certification core and history data including the verification history of the artificial intelligence model, by the at least one processor.

A computer program stored on a computer-readable recording medium for executing the method on a computer device in conjunction with the computer device is provided.

A computer-readable recording medium having recorded thereon a computer program for executing the method on a computer device is provided.

A method and system for verifying and certifying mobile AI (Artificial Intelligence) based on a micro agent may be provided.

### BRIEF DESCRIPTION OF THE DRAWINGS

FIG. 1 is a drawing illustrating an example of a network environment according to an embodiment of the present invention;

FIG. 2 is a drawing illustrating an example of a computer device according to an embodiment of the present invention;

FIG. 3 is a drawing illustrating an example of a progressive verification framework according to an embodiment of the present invention;

FIG. 4 is a drawing illustrating an example of an internal configuration of a system for verifying and certifying AI (Artificial Intelligence) according to an embodiment of the present invention;

FIG. 5 is a drawing illustrating an example of a process for verifying and certifying AI according to an embodiment of the present invention;

FIG. 6 is a drawing illustrating an example of operation of a benchmark test executor as a submodule of a performance verification agent according to an embodiment of the present invention;

FIG. 7 is a drawing illustrating an example of operation of a resource profiler as a submodule of a performance verification agent according to an embodiment of the present invention;

FIG. 8 is a drawing illustrating an example of operation of a verification task scheduler as a submodule of a meta verification controller according to an embodiment of the present invention;

FIG. 9 is a drawing illustrating an example of operation of a result correlation analyzer as a submodule of a meta verification controller according to an embodiment of the present invention;

FIG. 10 is a drawing illustrating an example of operation of a data versioning controller as a submodule of a verification data manager according to an embodiment of the present invention;

FIG. 11 is a drawing illustrating an example of operation of a verification result cache manager as a submodule of a verification data manager according to an embodiment of the present invention;

FIG. 12 is a drawing illustrating an example of a detailed configuration of the system for verifying and certifying AI according to an embodiment of the present invention;

FIGS. 13 to 17 are drawings illustrating examples of AI agent verification/certification processes according to an embodiment of the present invention;

FIGS. 18 to 22 are drawings illustrating examples of system integration processes according to an embodiment of the present invention;

FIG. 23 is a drawing illustrating an example of an internal configuration of a large-scale AI agent distributed evaluation system according to an embodiment of the present invention;

FIG. 24 is a drawing illustrating an example of a large-scale AI agent distributed evaluation process according to an embodiment of the present invention;

FIG. 25 is a drawing illustrating an example of a K8s-based AI agent evaluation system architecture according to an embodiment of the present invention;

FIG. 26 is a drawing illustrating an example of a K8s network flow according to an embodiment of the present invention; and

FIG. 27 is a flow chart illustrating an example of a method for verifying and certifying AI of the system for verifying and certifying AI according to an embodiment of the present invention.

### DETAILED DESCRIPTION

Hereinafter, embodiments of the present invention will be described in detail with reference to the accompanying drawings.

A system for verifying and certifying AI (Artificial Intelligence) according to embodiments of the present invention may be implemented by at least one computer device. In this case, a computer program according to an embodiment of the present invention may be installed and executed on the at least one computer device implementing the system for verifying and certifying AI, and the at least one computer device may perform a method for verifying and certifying AI according to embodiments of the present invention under the control of the executed computer program. The aforementioned computer program may be stored in a computer-readable recording medium for executing the method for verifying and certifying AI on a computer in conjunction with the computer device.

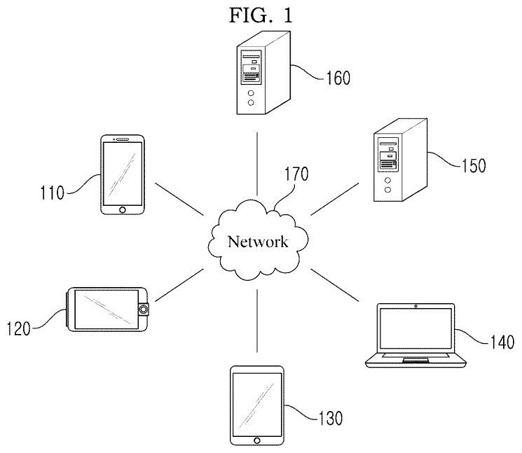

FIG. 1 is a drawing illustrating an example of a network environment according to an embodiment of the present invention. The network environment of FIG. 1 indicates an example including a plurality of electronic devices 110, 120, 130, and 140, a plurality of servers 150 and 160, and a network 170. Such FIG. 1 is provided as an example only and the number of electronic devices or the servers is not limited as FIG. 1.

The plurality of electronic devices 110, 120, 130, and 140 may be stationary terminals or mobile terminals implemented with a computer system. As examples of the plurality of electronic devices 110, 120, 130, and 140, there are a smartphone, a mobile phone, a navigation device, a computer, a laptop computer, a terminal for digital broadcasting, PDA (Personal Digital Assistants), a PMP (Portable Multimedia Player), a tablet PC, a game console, a wearable device, an IoT (Internet of Things) device, a VR (Virtual Reality) device, an AR (Augmented Reality) device, etc. As an example, in FIG. 1, a shape of a smartphone is illustrated as an example of the electronic device 110, but in the embodiments of the present disclosure, the electronic device 110 may mean one of various physical computer systems capable of communicating with other electronic devices 120, 130, and 140 and/or the servers 150 and 160 through the network 170 by substantially using wireless or wired communication method.

A communication method is not limited, and may include short-distance wireless communication between devices in addition to communication methods using communication networks (e.g., a mobile communication network, wired Internet, wireless Internet, a broadcasting network, a satellite network, and the like) which may be included in the network 170. For example, the network 170 may include one or more any networks of a PAN (personal area network), a LAN (local area network), a CAN (campus area network), a MAN (metropolitan area network), a WAN (wide area network), a BBN (broadband network), and the Internet. Furthermore, the network 170 may include any one or more of network topologies, including a bus network, a star network, a ring network, a mesh network, a star-bus network, and a tree or hierarchical network, but is not limited thereto.

Each of the servers 150 and 160 may be implemented with a computer device or a plurality of computer devices for providing instructions, code, files, contents, or services by communicating with the plurality of electronic devices 110, 120, 130, and 140 through the network 170. For example, the server 150 may be a system that provides a first service to the plurality of electronic devices 110, 120, 130, and 140 connected through the network 170, and the server 160 also may be a system that provides a second service to the plurality of electronic devices 110, 120, 130, and 140 connected through the network 170. As more particular example, through an application as a computer program installed and operated on the plurality of electronic devices 110, 120, 130, and 140, the server 150 may provide a service targeted by the corresponding application (e.g., search service and the like) as the first service to the plurality of electronic devices 110, 120, 130, and 140. As another example, the server 160 may provide a service for distributing a file for installation and operation of the above-described application to the plurality of electronic devices 110, 120, 130, and 140 as the second service.

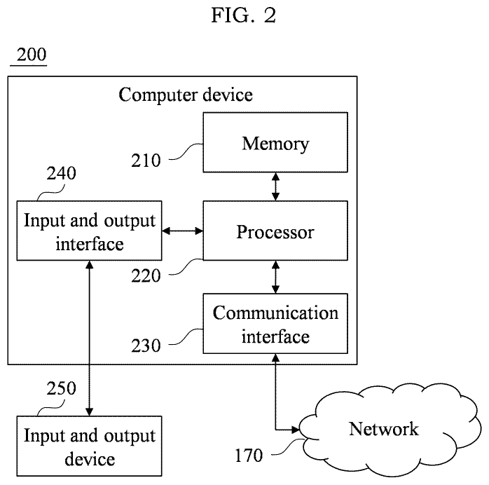

FIG. 2 is a block diagram illustrating an example of a computer device according to an embodiment. Each of the plurality of electronic devices 110, 120, 130, and 140 or each of the servers 150 and 160 described above may be implemented by a computer device 200 shown in FIG. 2.

As illustrated in FIG. 2, such computer device 200 may include a memory 210, a processor 220, a communication interface 230, and an input/output (I/O) interface 240. The memory 210 is a computer-readable recording medium, and may include permanent mass storage devices, such as a RAM (random access memory), a ROM (read only memory) and a disk drive. Here, the permanent mass storage device, such as a ROM and a disk drive, may be included in the computer device 200 as a permanent storage device separated from the memory 210. Furthermore, an operating system and at least one program code may be stored in the memory 210. Such software components may be loaded from a computer-readable recording medium separated from the memory 210 to the memory 210. Such separate computer-readable recording medium may include computer-readable recording media, such as a floppy drive, a disk, a tape, a DVD/CD-ROM drive, a memory card, and the like. In another embodiment, software components may be loaded onto the memory 210 through the communication interface 230, not a computer-readable recording medium. For example, the software components may be loaded onto the memory 210 of the computer device 200 based on a computer program installed by files received through the network 170.

The processor 220 may be configured to process instructions of a computer program by performing basic arithmetic, logic and I/O operations. The instructions may be provided to the processor 220 by the memory 210 or the communication interface 230. For example, the processor 220 may be configured to execute instructions received according to program code stored in a recording device, such as the memory 210.

The communication interface 230 may provide a function for enabling the computer device 200 to communicate with other devices (e.g. the above-described storing devices) through the network 170. For example, a request, an instruction, data or a file generated by the processor 220 of the computer device 200 according to program code stored in a recording device such as the memory 210 may be transmitted to other devices through the network 170 according to control of the communication interface 230. Inversely, a signal, an instruction, data or a file from another device may be received to the computer device 200 through the communication interface 230 of the computer device 200 passing through the network 170. A signal, an instruction or data and the like received through the communication interface 230 may be transmitted to the processor 220 or the memory 210, and a file may be stored in a storage medium (the above-described permanent storage device) which may be further included in the computer device 200.

The I/O interface 240 may be means for interface with an input/output (I/O) device 250. For example, the input device may include a device such as a microphone, a keyboard or a mouse and the like, and the output device may include a device such as a display or a speaker. For another example, the I/O interface 240 may be means for interface with a device in which functions for input and output have been integrated into one, such as a touch screen. The I/O devices 250, together with the computer device 200, may be configured as a single device.

Furthermore, in other embodiments, the computer device 200 may include components less or more than the components of FIG. 2. However, it is not necessary to clearly illustrate most of conventional components. For example, the computer device 200 may be implemented to include at least some of the I/O device 250 above described or may further include other components such as a transceiver, a database, etc.

A system for verifying and certifying AI (Artificial Intelligence) according to the embodiment may include a hierarchical verification agent system, a meta verification system, an adaptive verification protocol, and a verification result feedback system.

### 1. Hierarchical Verification Agent System

### 1.1 Micro Verification Agent Architecture

The hierarchical verification agent system may be composed of specialized small-scale AI verification agents, each of which may be responsible for a specific evaluation domain. Each micro verification agent may operate independently and generate verification results, and cross-verification may be performed through collaboration among the verification agents. Furthermore, when a new verification requirement arises, the system may be easily expanded by adding only the relevant micro agent.

### 1.2 Types of Major Micro Verification Agents

Micro verification agents are divided into several types, and the roles of each are as follows.

First, a performance verification agent is capable of measuring performance metrics such as response time, throughput, and accuracy of the AI agent. It can also perform stress tests and load tests to evaluate the system's limitations, and analyze resource utilization efficiency to derive optimization strategies.

Second, a bias verification agent may verify the diversity and representativeness of the dataset used for training the AI agent and analyze fairness with respect to protected attributes. Through this, it can evaluate whether statistical bias exists in the decision-making results of the AI model.

Third, a security verification agent may perform adversarial attack simulations on the AI agent and examine the possibility of data privacy breaches. It also can evaluate resistance to model reverse engineering to analyze security vulnerabilities.

Fourth, a stability verification agent may verify the AI agent's operation under boundary conditions and evaluate its ability to handle exceptional situations. Additionally, it can analyze whether performance degradation occurs during long-term operation to ensure the sustained stability of the AI system.

### 2. Meta Verification System

2.1 Collaboration Framework among Verification Agents

In the meta verification system, a meta verification controller coordinates the execution of each verification agent and performs cross-analysis of mutual verification results among the agents. This enables the overall verification process to ensure accuracy and reliability.

### 2.2 Verification Reliability Evaluation Framework

The verification reliability evaluation framework may be composed of an internal consistency verification and a cross-verification mechanism.

First, the internal consistency verification checks the consistency of verification results repeatedly performed by the same verification agent and analyzes the temporal stability of the verification results. It also evaluates the reproducibility of the verification process to determine whether consistent results are derived under identical conditions.

Next, the cross-verification mechanism checks the consistency of results among different verification agents, and in cases where conflicting results arise, applies arbitration logic to derive results with higher reliability. Finally, the reliability of the verification results can be quantified to ensure the reliability of the verification system.

### 3. Adaptive Verification Protocol

### 3.1 Context Aware Verification System

The adaptive verification protocol may include functionality that automatically adjusts the level of verification based on the intended use and risk level of the AI agent. By utilizing previous verification history and operational data, the scope of verification can be optimized, and if new vulnerabilities or risk patterns are detected, the verification protocol can be automatically updated.

### 3.2 Progressive Verification Framework

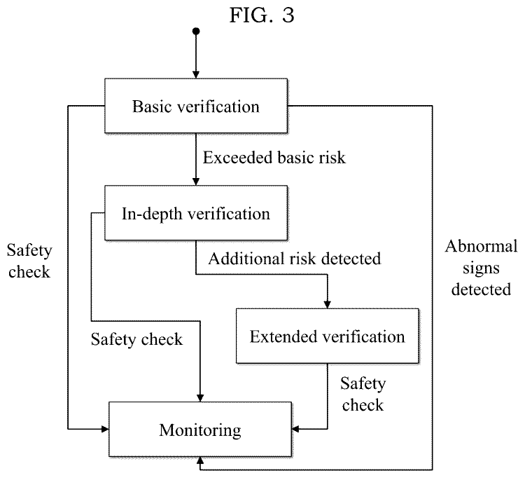

FIG. 3 is a drawing illustrating an example of a progressive verification framework according to an embodiment of the present invention. The progressive verification framework may be composed of three processes: a basic verification process, an advanced verification process, and an extended verification process. First, in the basic verification process, essential safety and performance metrics are verified, and a fast verification cycle is supported to provide immediate feedback. Next, the advanced verification process verifies more detailed quality metrics and performs various scenario-based tests. Long-term impact analysis can also be conducted to evaluate the sustainability of the AI system. Finally, in the extended verification progress, in-depth analysis for specific or exceptional situations is performed, and an external expert review process can be integrated. Furthermore, compliance with regulations is verified to ensure that legal requirements are met.

### 4. Verification Result Feedback System

### 4.1 Automated Improvement Suggestion Engine

The verification result feedback system includes an automated improvement suggestion engine, which can automatically generate specific improvement plans for detected issues. It may also recommend solutions based on similar past cases and track improvement history to analyze effectiveness.

### 4.2 Continuous Monitoring Framework

For continuous verification during AI system operation, the system may monitor performance in real operation environments and collect and analyze user feedback. This allows for early detection and warning of abnormal signs, thereby minimizing the occurrence of issues.

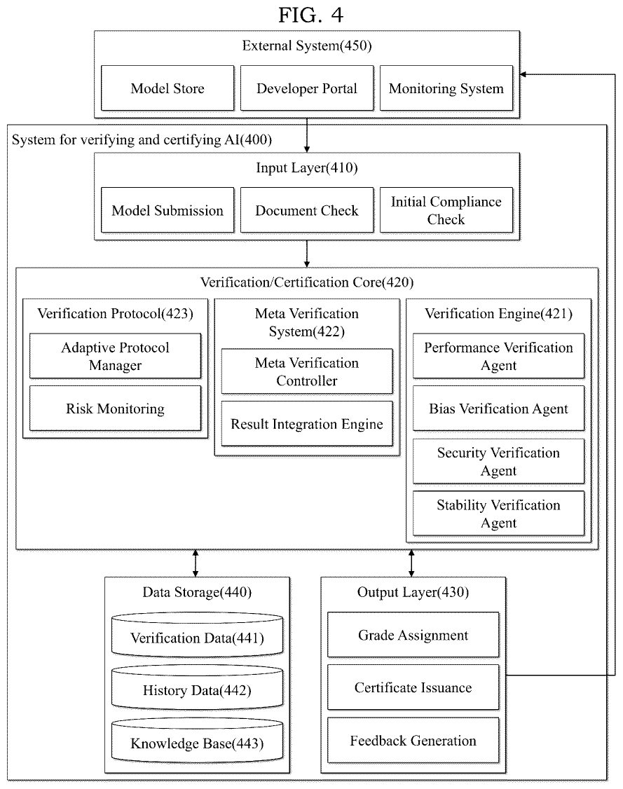

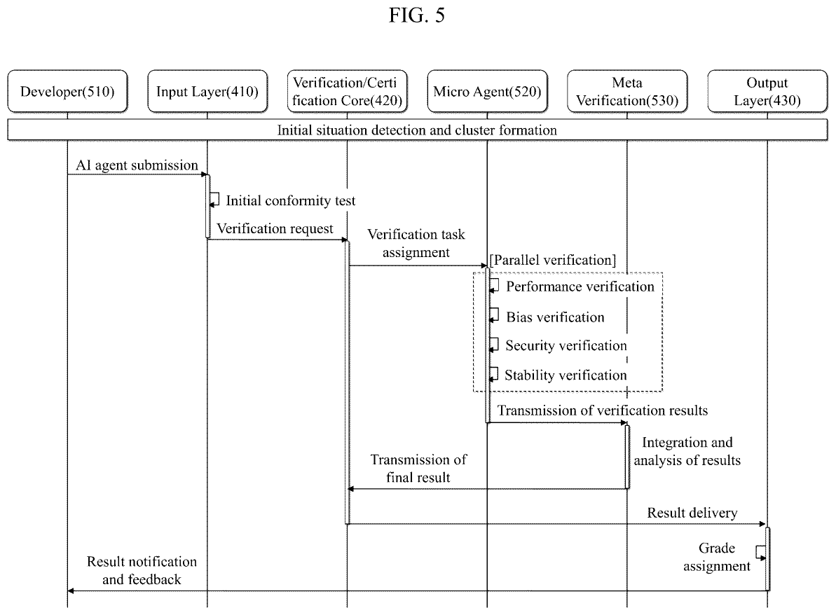

FIG. 4 is a drawing illustrating an example of an internal configuration of a system for verifying and certifying AI (Artificial Intelligence) according to an embodiment of the present invention, and FIG. 5 is a drawing illustrating an example of a process for verifying and certifying AI according to an embodiment of the present invention.

A system for verifying and certifying AI 400 may include four main components: an input layer 410, a verification/certification core 420, an output layer 430, and a data storage 440.

First, the input layer 410 may be responsible for registering basic information of the AI agent submitted by a developer 510. Then, the input layer 410 may perform a document checking process to examine the appropriateness of required documents and metadata, followed by an initial compliance check to determine whether basic requirements are satisfied.

The verification/certification core 420 is the main area where actual verification takes place, and may include a verification engine 421 composed of a group of specialized micro verification agents. A meta verification system 422 that integrates individual verification results and performs cross-verification may support this, and a verification protocol 423 that manages context-optimized verification procedures may be applied.

In the output layer 430, the performance and conformity of the verified AI agent are comprehensively evaluated to assign a grade. Then, the output layer 430 may issue an official certificate for the verified model and additionally generate feedback including improvement suggestions and recommendations.

Finally, the data storage 440 may be composed of verification data 441 for storing data generated during the verification process, history data 442 for managing the verification history for each model, and a knowledge base 443 for storing verification criteria and reference data. This allows continuous improvement in verification quality and consistent application of verification criteria.

The verification engine 421, as a micro verification agent module, may include a performance verification agent, a bias verification agent, a security verification agent, and a stability verification agent.

The performance verification agent may serve to quantitatively measure performance metrics such as the accuracy, speed, and resource efficiency of an AI agent. The main purpose of this agent is to verify whether the actual performance of the model meets the specified performance metrics. For this, the performance verification agent may perform performance tests using benchmark datasets and monitor resource usage through real-time profiling. In addition, it may evaluate performance under various operational environments by automating load tests and stress tests, and generate verification reports based on statistical performance analysis.

The bias verification agent may be responsible for evaluating ethical aspects and fairness of an AI model. The main purpose is to verify whether discriminatory results occur for specific groups or attributes. For this, the bias verification agent may analyze performance disparities across various demographic groups and measure the impact of protected attributes on model performance. Also, the bias verification agent may calculate fairness metrics to evaluate whether the model maintains fairness, and generate recommendations for mitigating bias.

The security verification agent may serve to evaluate security vulnerabilities and attack resistance of an AI model. The main purpose is to verify the ability to defend against malicious attacks and data leakage. For this, the security verification agent may conduct automated penetration tests and evaluate the resistance to model reverse engineering attempts. Furthermore, the security verification agent may verify the level of data privacy protection, and scan for security vulnerabilities to generate reports that help enhance the AI model's security.

The stability verification agent may serve to evaluate long-term stability and reliability of an AI model. The main purpose is to verify whether the model operates stably under various operating conditions. For this, the stability verification agent may conduct long-term execution tests, evaluate the ability to handle exceptional situations, and verify stability in response to system resource fluctuations. Additionally, the stability verification agent may perform model drift detection to monitor changes in model performance over time, thereby ensuring continuous reliability of the AI system.

The meta verification system 422, as a meta-verification controller, may include a meta verification controller and a result integration engine.

The meta verification controller (or verification process manager) may serve to control and coordinate the overall flow of the verification process. The main purpose is to support the efficient operation of each verification agent and to effectively integrate verification results. For this, the meta verification controller may schedule verification tasks, manage priorities, and allocate resources appropriately among verification agents. In addition, the meta verification controller may monitor the verification progress in real time and respond immediately when anomalies are detected.

The result integration engine (or result integration analyzer) may serve to comprehensively analyze and evaluate various verification results. The main purpose is to derive a final determination by integrating the results from individual verification agents. For this, the result integration engine may integrate multi-dimensional evaluation metrics, analyze correlations among results, and compute a composite score based on weighted factors. Ultimately, the result integration engine may execute logic that uses this data to determine the certification grade of the AI model.

The output layer (or verification result processor) may include a feedback generator and a certificate manager.

The feedback generator may serve to generate improvement recommendations based on the verification results. The main purpose is to provide developers with specific and actionable feedback to help them improve AI agents. For this, the feedback generator may classify detected issues, assign priorities, and run algorithms to recommend solutions. Additionally, the feedback generator may produce customized feedback reports and provide step-by-step improvement guides to support enhancement of the AI model's performance and reliability.

The certificate manager may serve to manage the certification information of the verified AI agents. The main purpose is to track and update the certification status of AI models as needed. For this, the certificate manager may issue and manage digital certificates, and monitor the validity period of certifications. Also, the certificate manager may track certification status in real time, and store certification histories in a database to continuously maintain the reliability of AI models.

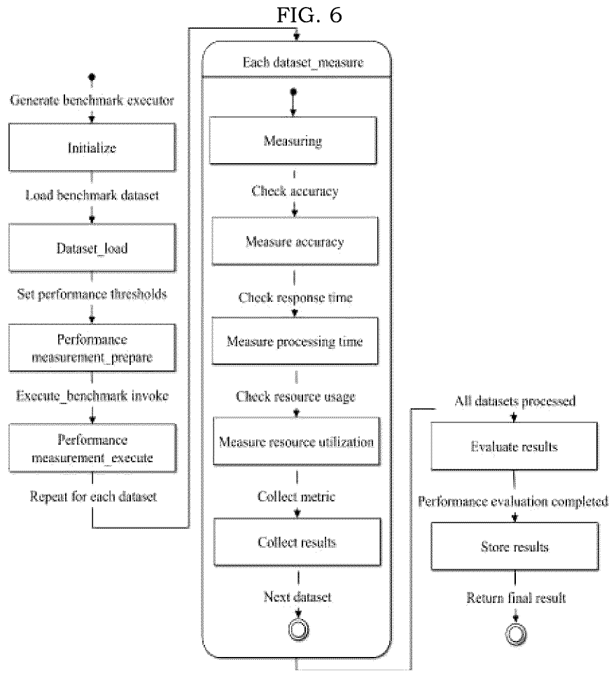

FIG. 6 is a drawing illustrating an example of operation of a benchmark test executor as a submodule of a performance verification agent according to an embodiment of the present invention. The benchmark test executor may serve to evaluate the performance of an AI agent in a standardized manner and to measure the results. The main purpose is to conduct quantitative performance tests to verify whether the AI model meets the required criteria. For this, the benchmark test executor may take as input the AI agent to be tested, a benchmark dataset, and performance thresholds to perform the evaluation. The test results may include performance metrics such as model accuracy, processing time, and resource usage, which can be used to objectively analyze the AI model's performance.

Table 1 below illustrates an example of the operation of the benchmark test executor.

```
TABLE 1
‘‘‘python
  class BenchmarkExecutor:
    def _{——}init_{——}(self, benchmark_datasets, performance_criteria):
      self.datasets = benchmark_datasets
      self.criteria = performance_criteria
      self.metrics = MetricsCollector( )
    def execute_benchmark(self, ai_agent):
      results = { }
      for dataset in self.datasets:
        # measure performance by dataset
        perf_metrics = self.measure_performance(ai_agent, dataset)
        # evaluate performance against thresholds
        evaluation = self.evaluate_metrics(perf_metrics)
        results[dataset.id] = evaluation
      return results
  ‘‘‘
```

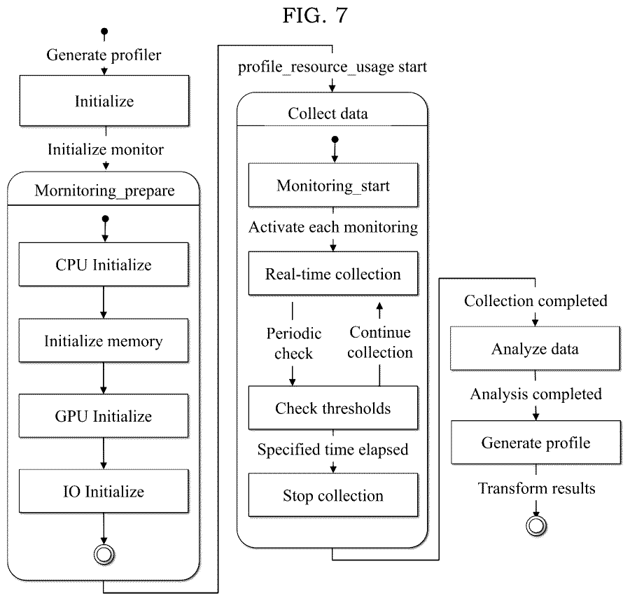

FIG. 7 is a drawing illustrating an example of operation of a resource profiler as a submodule of a performance verification agent according to an embodiment of the present invention. The resource profiler may serve to analyze resource usage patterns of an AI agent. The main purpose is to measure how computational resources such as CPU, GPU, and NPU, as well as system resources like memory and I/O, are consumed during the execution of the AI model, in order to evaluate optimization potential. For this, the resource profiler may collect resource usage data from the running AI agent in real time, and provide detailed profiling results such as CPU/GPU/NPU utilization rates, memory consumption, and I/O patterns. Through this analysis, it is possible to improve the resource efficiency of the AI model and derive insights for performance optimization.

Table 2 below illustrates an example of the operation of the resource profiler.

TABLE 2

```
‘‘‘python
  class ResourceProfiler:
    def _{——}init_{——}(self, sampling_interval=0.1):
      self.interval = sampling_interval
      self.monitors = {
        ‘cpu’: CPUMonitor( ),
        ‘memory’: MemoryMonitor( ),
        ‘gpu’: GPUMonitor( ),
        ‘npu’: NPUMonitor( ),
        ‘io’: IOMonitor( )
      }
    def profile_resource_usage(self, ai_agent, duration):
      profile_data = { }
      for monitor in self.monitors.values( ):
        # start monitoring each resource
        monitor.start_monitoring(ai_agent)
        # collect data over fixed period
        time.sleep(duration)
        # collect monitoring results
        profile_data[monitor.type] = monitor.collect_data( )
      return self.analyze_profile_data(profile_data)
  ‘‘‘
```

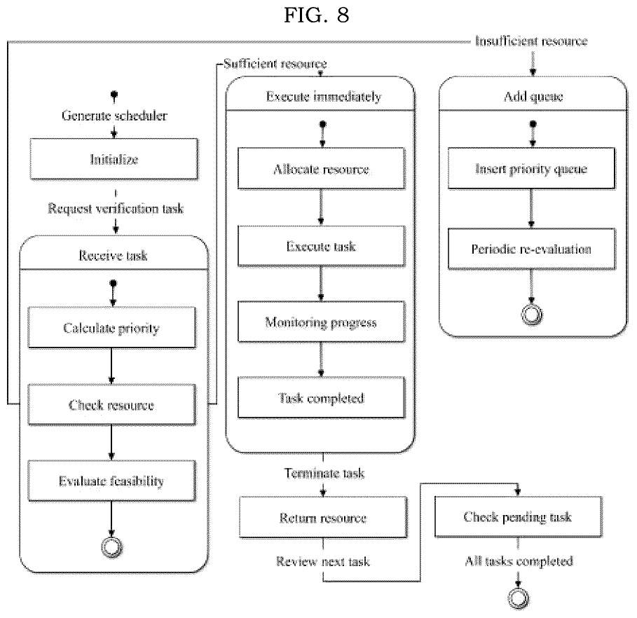

FIG. 8 is a drawing illustrating an example of operation of a verification task scheduler as a submodule of a meta verification controller according to an embodiment of the present invention. The verification task scheduler may serve to efficiently schedule multiple verification tasks and manage the execution. The main purpose is to handle concurrent verification requests smoothly by optimizing system resources. For this, the verification task scheduler may analyze inputs such as the verification task queue, system resource status, and priority policies to establish an optimized task execution plan. Also, the verification task scheduler may allocate appropriate resources to each verification task to ensure the smooth progression of the verification process, and maximize resource utilization.

Table 3 below illustrates an example of the operation of the verification task scheduler.

```
TABLE 3
‘‘‘python
  class ValidationScheduler:
    def _{——}init_{——}(self, resource_manager):
      self.resource_manager = resource_manager
      self.task_queue = PriorityQueue( )
      self.running_tasks = { }
    def schedule_validation_task(self, validation_task):
      # determine task priority
      priority = self.calculate_priority(validation_task)
      # check resource availability
      available_resources = self.resource_manager.check_availability( )
      if self.can_execute_immediately(validation_task, available_resources):
        # if immediate execution is possible
        self.execute_task(validation_task)
      else:
        # add to the queue
        self.task_queue.put((priority, validation_task))
  ‘‘‘
```

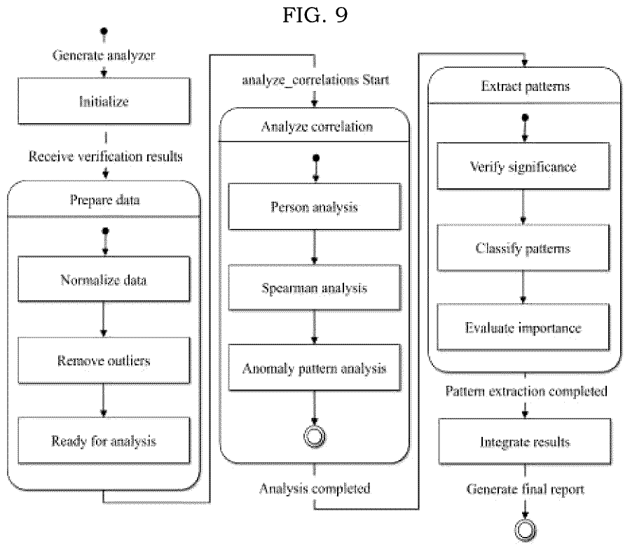

FIG. 9 is a drawing illustrating an example of operation of a result correlation analyzer as a submodule of a meta verification controller according to an embodiment of the present invention. The result correlation analyzer may serve to analyze correlations and patterns among various verification results. The main purpose is to integrate the result data from multiple verification agents, identify relationships among them, and detect significant patterns. For this, the result correlation analyzer may receive the result data provided by each verification agent as input and perform analysis. As a result of the analysis, a report describing the correlations among the verification results can be generated, and if any anomalous patterns are detected, detailed information regarding those patterns may also be provided. Through this analysis, the reliability of the verification process may be increased, and potential issues or areas for improvement may be early identified.

Table 4 below illustrates an example of the operation of the result correlation analyzer.

```
TABLE 4
‘‘‘python
  class ResultCorrelationAnalyzer:
    def _init_{——}(self):
      self.correlation_methods = {
        ‘pearson’: PearsonCorrelation( ),
        ‘spearman’: SpearmanCorrelation( ),
        ‘anomaly’: AnomalyDetector( )
      }
    def analyze_correlations(self, validation_results):
      correlations = { }
      for method_name, analyzer in self.correlation_methods.items( ):
        # calculate correlation for each analysis method
        result = analyzer.calculate_correlation(validation_results)
        # extract significant patterns
        patterns = analyzer.extract_patterns(result)
        correlations[method_name] = {
          ‘correlation_result’: result,
          ‘significant_patterns': patterns
        }
      return correlations
  ‘‘‘
```

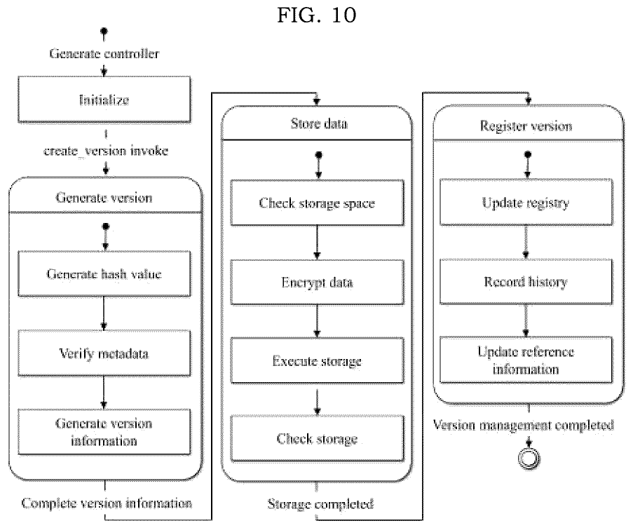

FIG. 10 is a drawing illustrating an example of operation of a data versioning controller as a submodule of a verification data manager according to an embodiment of the present invention. The data versioning controller may serve to manage versions of verification data and track the history of verification data. The main purpose is to systematically manage each version of the dataset used for verification when it is modified or updated over time, and to track the modification history compared to previous versions. For this, the data versioning controller may receive verification data and version metadata as input, generate version-controlled datasets, and record the modification history of those datasets. This functionality allows clear tracking of dataset modifications and supports easy access to previous versions when necessary.

Table 5 below illustrates an example of the operation of the data versioning controller.

TABLE 5

```
‘‘‘python
  class DataVersionController:
    def _{——} init_{——}(self, storage_manager):
      self.storage = storage_manager
      self.version_registry = VersionRegistry( )
    def create_version(self, dataset, metadata):
      # generate data hash value
      hash_value = self.calculate_hash(dataset)
      # generate version information
      version_info = {
        ‘hash’: hash_value,
        ‘timestamp’: time.now( ),
        ‘metadata’: metadata
      }
      # storing data and registering version
      storage_id = self.storage.store(dataset, version_info)
      self.version_registry.register(storage_id, version_info)
      return version_info
  ‘‘‘
```

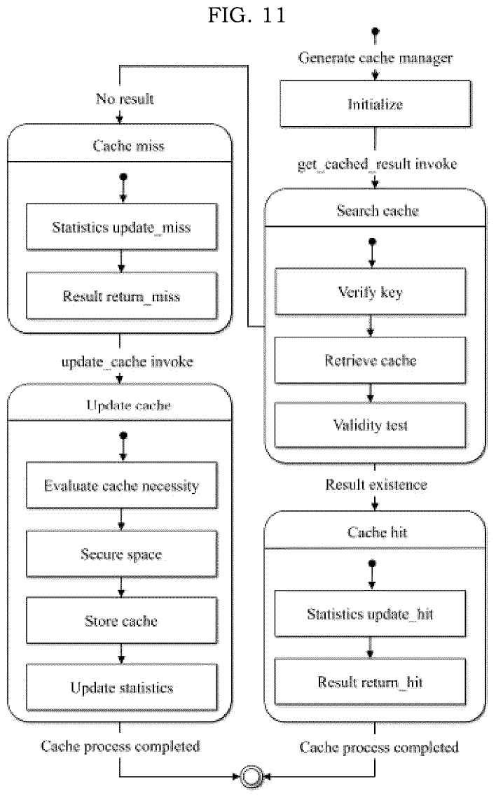

FIG. 11 is a drawing illustrating an example of operation of a verification result cache manager as a submodule of a verification data manager according to an embodiment of the present invention. The verification result cache manager may serve to efficiently cache and manage frequently used verification results. The main purpose is to optimize system performance by quickly providing verification results that are repeatedly requested. For this, the verification result cache manager may receive verification result data and cache policies as input, and store data in the cache or retrieve it from the cache when necessary. It may check for cache hits and output the cached result data, thereby reducing redundant verification tasks and improving processing speed. Also, in the event of a cache miss, the verification result cache manager may generate new results based on the original verification data and store them in the cache.

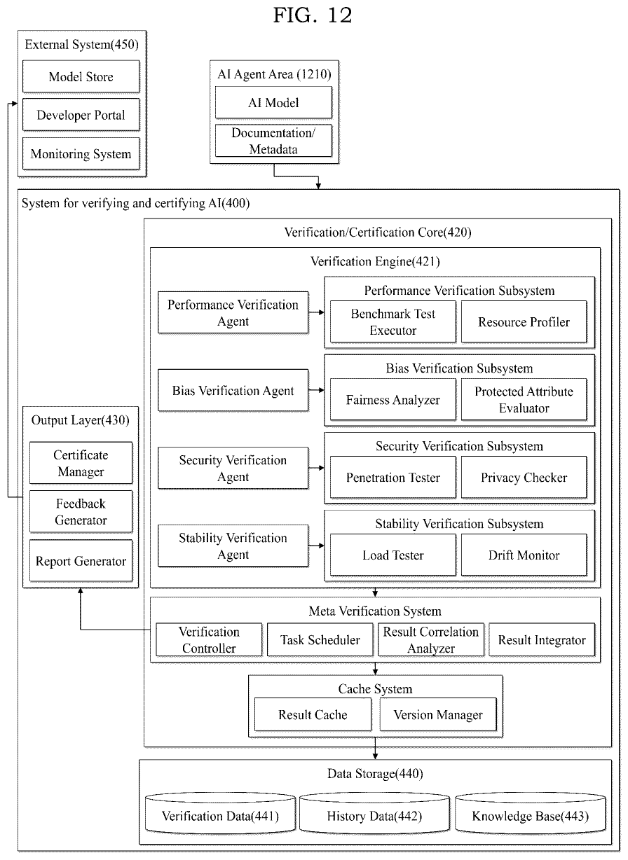

FIG. 12 is a drawing illustrating an example of a detailed configuration of the system for verifying and certifying AI according to an embodiment of the present invention.

In an AI Agent area 1210, an AI model refers to the artificial intelligence model subject to verification, and the model-related documents and metadata may include documentation materials and metadata associated with the model.

In the micro verification agent group of the verification engine 421, each verification agent may include an independent subsystem. A performance verification subsystem may perform standardized performance tests through a benchmark executor and analyze system resource usage using a resource profiler. A bias verification subsystem may analyze decision bias in the AI model through a fairness analyzer and evaluate the impact on sensitive attributes using a protected attribute evaluator. A security verification subsystem may inspect model security vulnerabilities using a penetration tester and evaluate the level of data privacy protection through a privacy checker. A stability verification subsystem may verify the model's stability under system load using a load tester, and track changes in model performance via a drift monitor.

The meta verification system 422 may play a critical role in managing the verification process. The verification controller may control the overall verification process, while the task scheduler may manage the priority of verification tasks to enable efficient execution. The result correlation analyzer may analyze the correlation between verification results to identify the relationship between the results, and the result integrator may integrate the results from various verification agents to derive a final result.

The cache system may serve to provide frequently used data quickly. The result cache may store frequently used verification results to improve processing speed, and the version manager may manage versions of models and verification results, enabling history tracking.

The data storage 440 may systematically store and manage data related to verification. The verification data 441 may store data generated during actual verification processes, the history data 442 may manage past verification results and histories, and the knowledge base 443 may store verification criteria and reference data to ensure the reliability of the verification process.

The output layer 430 (or the output processing system) may serve to handle and deliver the verification results. The certificate manager may issue and manage certificates for AI models, and the feedback generator may derive improvement suggestions from verification results and generate feedback. The report generator may generate comprehensive verification results into report formats and deliver it.

An external system 450 may provide various services related to AI models. An AI model store may be a platform for storing and distributing AI models, and a developer portal may be a platform for providing developer support and information. A monitoring system may monitor the performance of models in real time, detect issues arising during operation, and issue alerts accordingly.

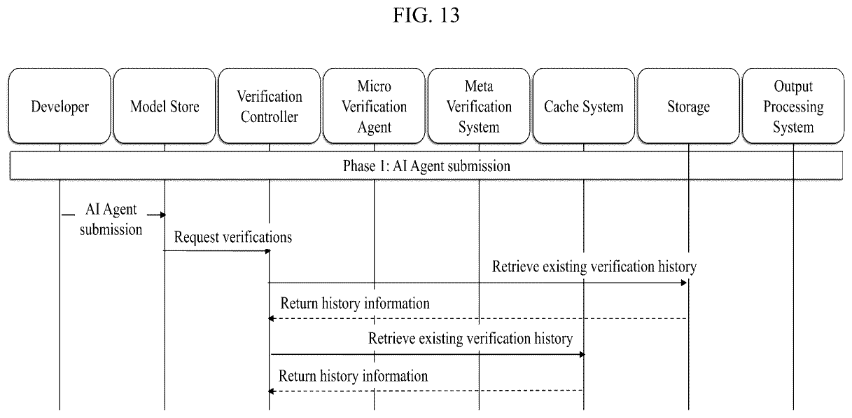

FIGS. 13 to 17 are drawings illustrating examples of AI agent verification/certification processes according to an embodiment of the present invention. The AI agent verification process may be composed of five phases.

In an AI agent submission phase (Phase 1) of FIG. 13, when a developer submits the AI agent via the model store, the verification controller may check the existing verification history and cache to determine the scope of verification. If an incremental update has been made, it may establish an optimized verification plan based on the changed components.

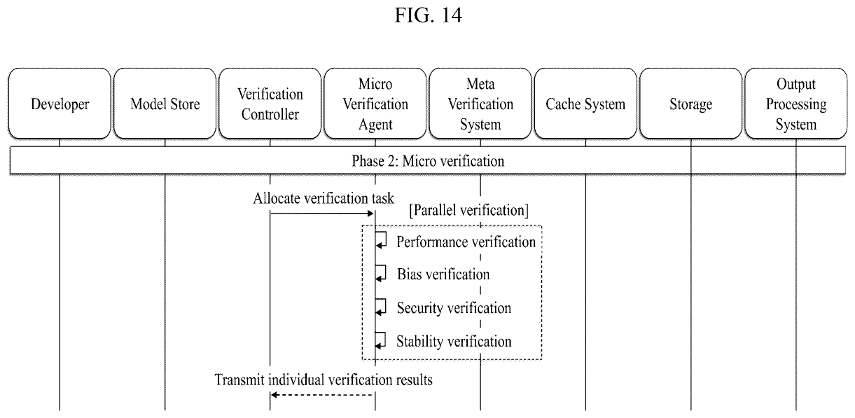

In a micro verification phase (Phase 2) of FIG. 14, four specialized verification agents—the performance verification agent, the bias verification agent, the security verification agent, and the stability verification agent—may perform verification in parallel. Each verification agent may operate independently and generate detailed, individual results. Additionally, a real-time monitoring system may track the progress of the verification process.

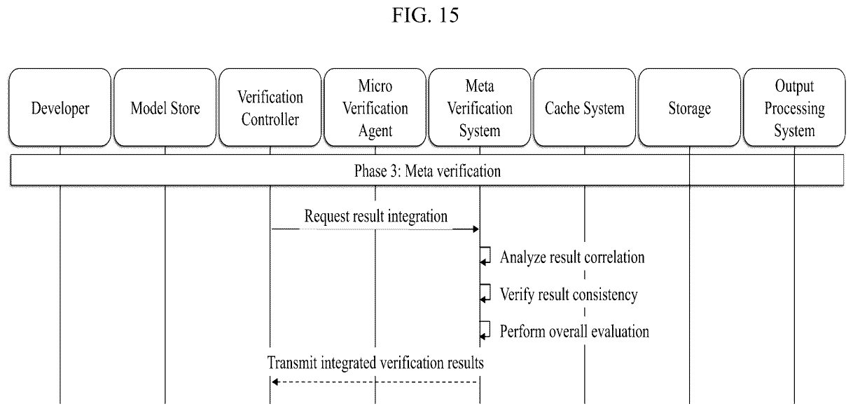

In a meta verification phase (Phase 3) of FIG. 15, the correlation between individual verification results may be analyzed to confirm consistency, and conflicts or abnormal patterns between the results may be detected or interpreted. Through this process, a comprehensive evaluation metric is produced, which is then used to determine the final grade.

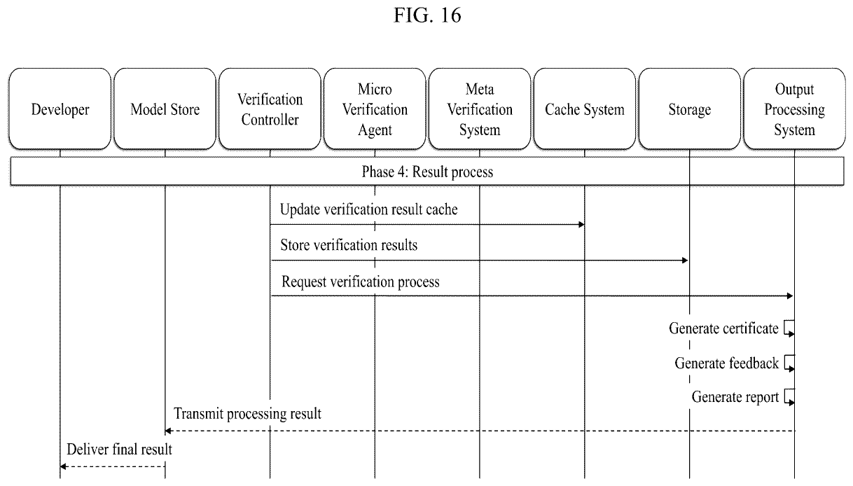

In a result process phase (Phase 4) of FIG. 16, the verification results may be recorded in the cache and storage for future reference. For the verified AI agent, a certificate, feedback, and detailed report may be generated in parallel, and all results may be delivered to the developer through the model store.

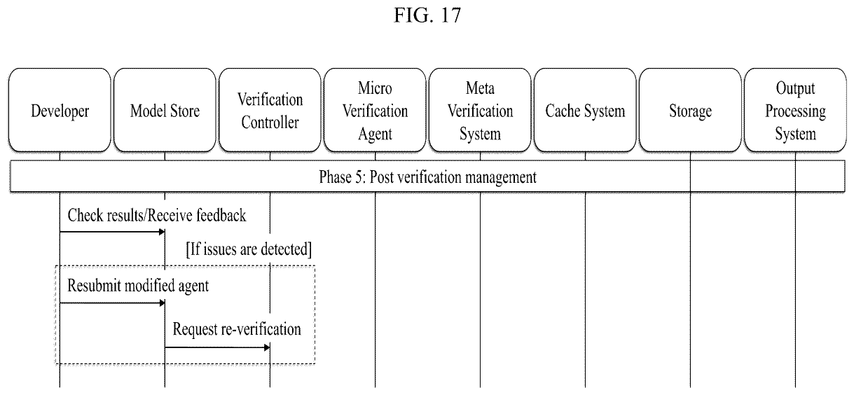

In a post verification management phase (Phase 5) of FIG. 17, the developer may review the verification results and make modifications if necessary. The modified AI agent may be processed through an optimized re-verification process, and through continuous monitoring, the quality of the certified AI agent may be maintained and managed.

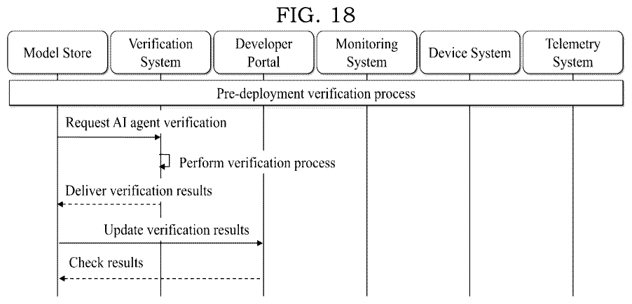

FIGS. 18 to 22 are drawings illustrating examples of system integration processes according to an embodiment of the present invention. The deployment and operation process of AI agents may be composed of five main processes.

In a pre-deployment verification process of FIG. 18, a verification request for the AI agent may be initiated from the model store to the verification system (the system for verifying and certifying AI 400). Once verification is complete in the verification system, the results are immediately delivered to the developer via the developer portal. All verification records may be stored and tracked for future reference.

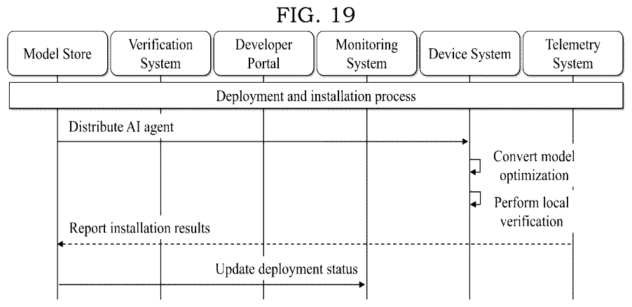

In a deployment and installation process of FIG. 19, the verified AI agent may be distributed to target device systems. In this process, the model may be optimized based on the specific characteristics of each device. After installation, local verification may be conducted to confirm proper functionality. The entire deployment status may be tracked through the monitoring system.

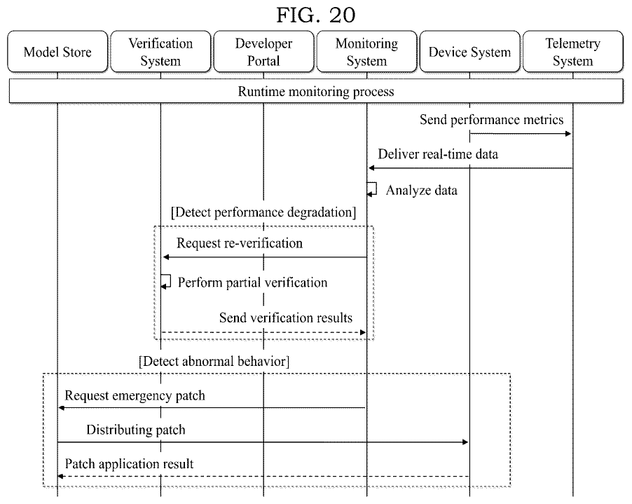

In a runtime monitoring process of FIG. 20, the device may send performance metrics to a telemetry system, and the monitoring system may perform real-time performance analysis. If performance degradation is detected, a re-verification request may be sent to the verification system. In cases of abnormal behavior, an emergency patch process may be initiated.

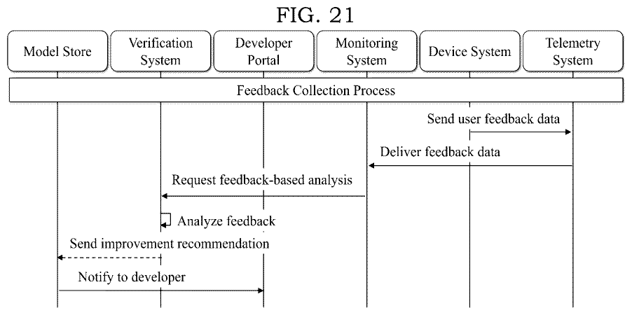

In a feedback collection process of FIG. 21, user feedback data may be collected from the device and analyzed by the verification system. Based on the analysis result, improvement recommendations may be generated and delivered to developers through the developer portal.

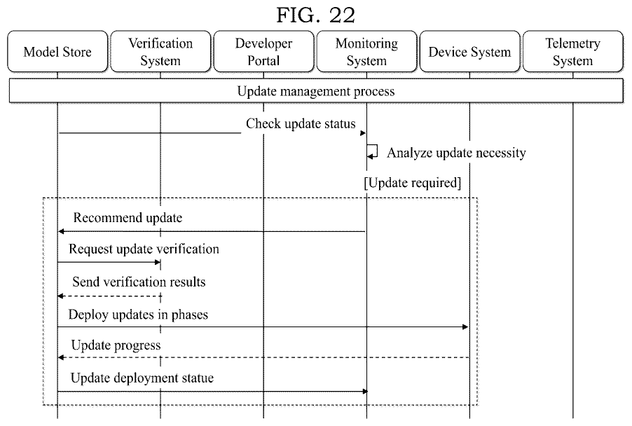

In an update management process of FIG. 22, the monitoring system determines whether an update is necessary. If so, the verification system may perform pre-verification. The verified updates are distributed incrementally, and the entire update process may be monitored in real time.

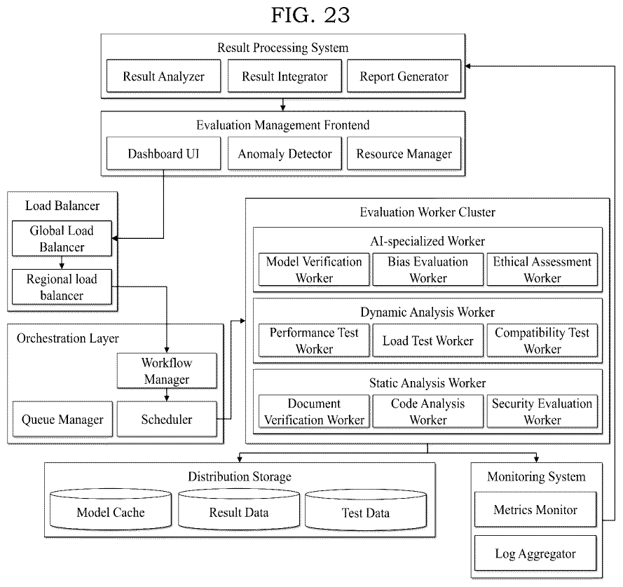

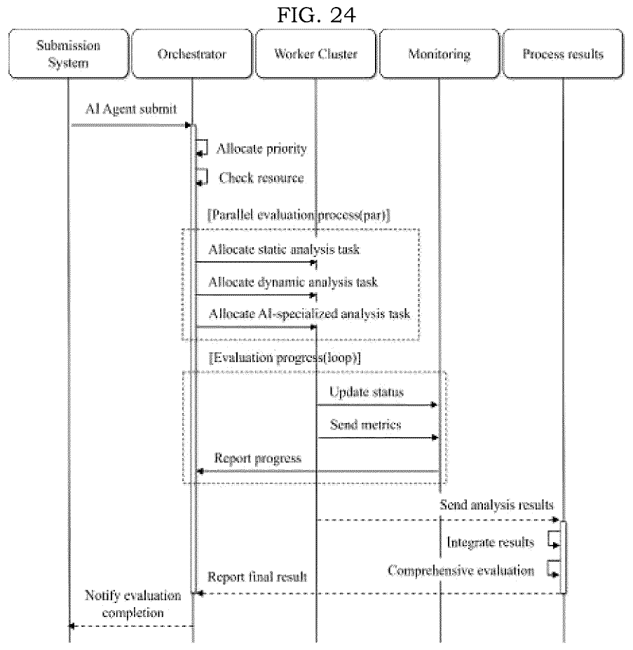

FIG. 23 is a drawing illustrating an example of an internal configuration of a large-scale AI agent distributed evaluation system according to an embodiment of the present invention. FIG. 24 is a drawing illustrating an example of a large-scale AI agent distributed evaluation process according to an embodiment of the present invention.

The large-scale AI agent distributed evaluation system may be composed of several key components.

An evaluation management frontend may monitor evaluation progress in real time, manage evaluation policies and criteria, and provide result dashboards and reports. It may also include functions to manage examiner's workflows. A load balancer may distribute global and regional loads, support auto scaling, and perform failover functions in the event of a failure. It also includes traffic monitoring and control functions. An orchestration layer manages workflows and task assignment, and it may optimize resource utilization and adjust scheduling based on task priorities. Also, it may efficiently manage the task queue.

An evaluation worker cluster may be composed of three main worker groups. Static analysis workers may perform document completeness verification, code quality analysis, security vulnerability evaluation, and license verification. Dynamic analysis workers are responsible for executing performance tests, performing load tests, compatibility verification, and stability tests. AI-specialized workers may secure reliability and fairness of the AI system by performing structure verification, bias analysis, ethical assessment, and accuracy verification of the AI model.

Such large-scale AI agent distributed evaluation system may be designed with a structure having scalability, reliability, and efficiency. In terms of scalability, it adopts a worker cluster structure that enables horizontal expansion, and may support dynamic resource allocation, container-based deployment, and microservice architecture. Also, for reliability, it may include automated failure recovery, data replication and backup, distributed transaction management, status monitoring and alerts. To maximize efficiency, it may perform parallel processing optimization, cache utilization, resource usage optimization, and task priority management.

The operation process of the large-scale AI agent distributed evaluation system may be composed of four main phases. In an examination receiving phase, the AI agent is submitted, an initial compliance test is conducted, priorities are assigned, and resources are reserved. In an evaluation execution phase, parallel evaluation process is conducted, real-time progress may be monitored, and abnormal situations may be detected and responded to. Also, intermediate results may be stored to ensure reliability. In a result processing phase, individual evaluation results are integrated, a comprehensive evaluation is performed, and a report may be generated to notify the results to the developer.

Monitoring and quality management are key elements for ensuring stable operation of the system. Through performance monitoring, it may track system resource utilization, processing speed and latency, error rate and failure rate, queue status, etc. in real-time. In the quality management, consistency of the evaluation results is verified, compliance with evaluation criteria is checked, and continuous process improvement and feedback reflection are performed.

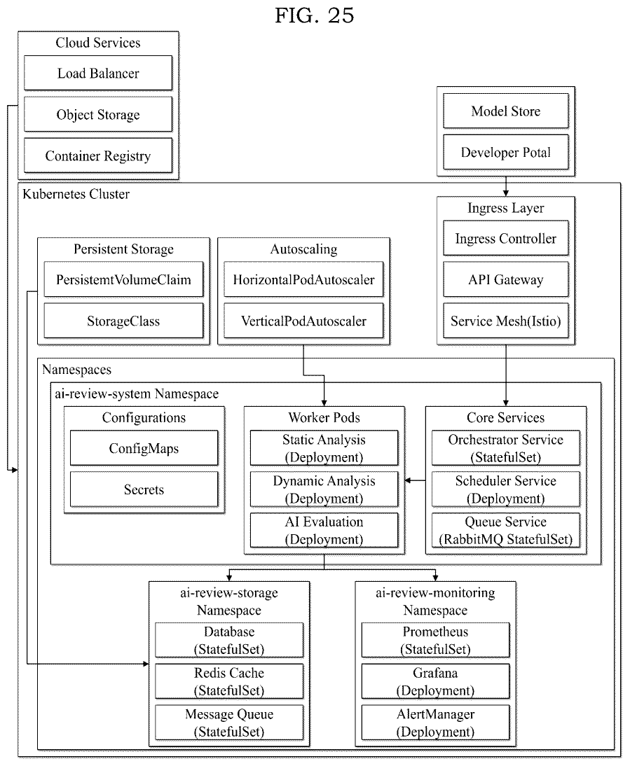

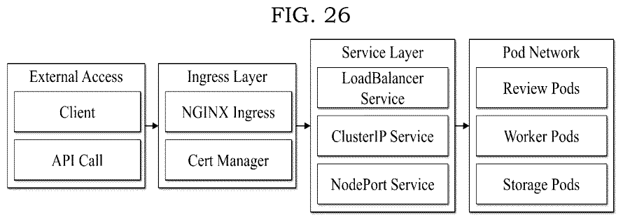

FIG. 25 is a drawing illustrating an example of a K8s-based AI agent evaluation system architecture according to an embodiment of the present invention. FIG. 26 is a drawing illustrating an example of a K8s network flow according to an embodiment of the present invention.

The cluster may be composed of multiple layers, and each layer is responsible for specific functions. The ingress layer is a layer for handling external traffic and may include an ingress controller, API gateway, and a service mesh (Istio). The ingress controller may route traffic based on NGINX, the API gateway may manage external API requests, and the service mesh may manage communications between services.

Core services may comprise several key services. An orchestrator service (StatefulSet) may coordinate the overall evaluation process, including state management and recovery, and workflow management. A scheduler service (Deployment) is responsible for task scheduling, resource allocation, and priority management. A queue service (RabbitMQ StatefulSet) manages task queues, supports asynchronous processing, and acts as a message broker.

Worker pods may be composed of workers for performing various analysis and evaluation tasks. Static analysis (Deployment) may be composed of workers for performing document verification, code analysis, and security testing, and auto-scaling settings may be applied. Dynamic analysis (Deployment) may be composed of workers for performing performance tests, load tests, and compatibility tests, and resource limits may be set. AI evaluation (Deployment) may be composed of workers for performing model verification, bias tests, and ethical assessments, and GPU resources may be efficiently managed.

Monitoring components may serve to track and manage the performance and status of the cluster. Monitoring stack may include various tools. Prometheus (StatefulSet) may collect metrics, store data, and process queries. Grafana (Deployment) may provide functions for dashboard visualization, alert setting, and report generation. AlertManager (Deployment) may manage alert, and perform escalation and alert grouping.

For storage components, various storage solutions are used to store and manage data within clusters. Persistent storage may provide persistent data storage, database (StatefulSet) is composed of PosgreSQL cluster, and perform data replication and backup management. Cache (Redis StatefulSet) may provide result caching, session management, and distributed cache functionalities. Message Queue (StatefulSet) may support task queues, event streams, and message persistence.

Automation and scalability: various technologies may be utilized to automate and scale cluster operations. Autoscaling may automatically adjust the cluster size based on resource utilization. HorizontalPodAutoscaler may scale pod horizontally, and support load-based scaling and resource utilization monitoring. VerticalPodAutoscaler may optimize performance by dynamically adjusting resource allocation, and predict resource. Finally, through CI (Continuous Integration)/CD (Continuous Deployment) Integration, deployment automation may be performed. For example, continuous integration and deployment are managed by utilizing Jenkins Pipeline, ArgoCD, and Helm Charts.

Tables 6 to 12 illustrate examples of formats of AI agent submission information.

```
TABLE 6
‘‘‘json
{
  “modelId”: “unique identifier”,
  “modelName”: “AI Agent name”,
  “version”: “version information (Semantic Versioning)”,
  “submissionDate”: “submission date,
  “developer”: {
    “organizationId”: “organization identifier”,
    “organizationName”: “organization name”,
    “developerName”: “developer name”,
    “contactEmail”: “contact email”,
    “contactPhone”: “contact phone”
  },
  “modelType”: “model type (e.g.: Classification, Detection, etc.)”,
  “intendedUse”: “purpose and intended use”,
  “targetDevices”: [“supported device list”]
}
‘‘‘
```

Table 6 illustrates an example of a format of basic information for AI agent submission.

TABLE 7

```
‘‘‘json
{
  “modelArchitecture”: {
    “type”: “model architecture type”,
    “framework”: “use framework”,
    “framework_version”: “framework version”,
    “model_format”: “model format (e.g.,: ONNX, TFLite, etc.)”
  },
  “requirements”: {
    “minimum_hardware”: {
      “cpu”: “minimum CPU requirement”,
      “memory”: “ minimum memory requirement ”,
      “storage”: “minimum storage”,
      “gpu”: “GPU requirement(select)”,
      “npu”: “NPU requirement(select)”
    },
    “supported_os”: [supported OS list”],
    “dependencies”: [required library and version”]
  },
  “performance”: {
    “latency”: “average latency”,
    “throughput”: “throughput per second”,
    “model_size”: “model size”,
    “memory_usage”: “memory usage during execution”
  }
}
‘‘‘
```

Table 7 illustrates an example of a format of technical specification for the AI agent submission.

TABLE 8

```
‘‘‘json
{
  ″training″: {
    ″dataset″: {
      ″name″: ″training dataset name″,
      ″version″: ″dataset version″,
      ″size″: ″dataset size″,
      ″description″: ″dataset description″
    },
    ″preprocessing″: {
      ″methods″: [″preprocessing method list″],
      ″parameters″: ″preprocessing parameter″
    },
    ″metrics″: {
      ″accuracy″: ″accuracy″,
      ″precision″: ″precision″,
      ″recall″: ″recall″,
      ″f1_score″: ″F1 score″,
      ″additional_metrics″: ″additional performance metrics″
    }
  },
  ″validation″: {
    ″method″: ″verification method″,
    ″dataset″: ″verification dataset information″,
    ″results″: ″verification results″
  }
}
‘‘‘
```

Table 8 illustrates an example of a format of training information for the AI agent submission.

TABLE 9

```
‘‘‘json
{
  ″security″: {
    ″data_privacy″: ″data privacy protection method″,
    ″encryption″: ″used encryption method″,
    ″vulnerability_assessment″: ″vulnerability assessment reulsts″
  },
  ″ethics″: {
    ″bias_assessment″: ″bias assessment results″,
    ″fairness_metrics″: ″fairness metrics″,
    ″intended_use_cases″: [″intended use cases″],
    ″prohibited_use_cases″: [″prohibited use cases″]
  }
}
‘‘‘
```

Table 9 illustrates an example of a format of security and ethics information for the AI agent submission.

TABLE 10

```
‘‘‘json
{
  ″deployment″: {
    ″installation_guide″: ″installation guide document link″,
    ″configuration″: ″setting information″,
    ″environment_variables″: ″environment variable information″
  },
  ″monitoring″: {
    ″logging_requirements″: ″logging requirements″,
    ″metrics_collection″: ″collected metrics information″,
    ″alert_thresholds″: ″alert threshold setting″
  },
  ″maintenance″: {
    ″update_policy″: ″update policy″,
    ″rollback_procedure″: ″rollback policy″,
    ″support_period″: ″support period″
  }
}
‘‘‘
```

Table 10 illustrates an example of a format of operational information for the AI agent submission.

TABLE 11

```
‘‘‘json
{
  ″licensing″: {
    ″model_license″: ″model license type″,
    ″third_party_licenses″: [″third party license information″]
  },
  ″compliance″: {
    ″certifications″: [″possession certification″],
    ″regulatory_compliance″: [″complied regulation″],
    ″gdpr_compliance″: ″GDPR compliance status″
  },
  ″liability″: {
    ″warranty″: ″quality warranty information″,
    ″disclaimer″: ″escape clause″
  }
}
‘‘‘
```

Table 11 illustrates an example of a format of legal information for the AI agent submission.

TABLE 12

```
- [ ] AI Agent executable file or model file
- [ ] Basic Information section completed
- [ ] Technical Specification section completed
- [ ] Training Information section completed
- [ ] Security and Ethics Information section completed
- [ ] Operational Information section completed
- [ ] Legal Information section completed
- [ ] Required documents attached
  - [ ] Detailed Technical Document
  - [ ] API Document
  - [ ] User Manual
  - [ ] License Document
  - [ ] Security Evaluation Report
```

Table 12 illustrates an example of a submission checklist.

Tables 13 to 22 below illustrate examples of requirements of initial conformity tests of the AI agent.

TABLE 13

```
‘‘‘json
{
  ″model_format_requirements″: {
    ″supported_formats″: [
      ″ONNX″,
      ″TFLite″,
      ″CoreML″,
      ″PyTorch Mobile″
    ],
    ″validation_checks″: [
      ″format version compatibility″,
      ″model file integrity″,
      ″inclusion of required metadata″
    ],
    ″size_limits″: {
      ″maximum_model_size″: ″500MB″,
      ″maximum_total_package_size″: ″1GB″
    }
  }
}
‘‘‘
```

Table 13 illustrates an example of requirements for model format conformity among the basic model requirements.

TABLE 14

```
‘‘‘json
{
  ″technical_requirements″: {
    ″inference_time″: {
      ″max_latency″: ″100ms/request″,
      ″batch_processing_capability″: true
    },
    ″resource_usage″: {
      ″max_memory_usage″: ″1GB″,
      ″max_cpu_usage″: ″50%″,
      ″max_gpu_usage″: ″80%″
    },
    ″precision_support″: [
      ″FP32″,
      ″FP16″,
      ″INT8″
    ]
  }
}
‘‘‘
```

Table 14 illustrates an example of technical specification requirements among the basic model requirements.

TABLE 15

```
‘‘‘json
{
  ″security_requirements″: {
    ″model_protection″: {
      ″encryption_required″: true,
      ″supported_encryption_methods″: [
        ″AES-256″,
        ″RSA-2048″
      ]
    },
    ″runtime_security″: {
      ″memory_protection″: true,
      ″secure_execution_environment″: true,
      ″anti_tampering_measures″: true
    },
    ″vulnerability_checks″: {
      ″static_analysis_required″: true,
      ″dynamic_analysis_required″: true,
      ″known_vulnerability_scan″: true
    }
  }
}
‘‘‘
```

Table 15 illustrates an example of requirements for model security verification among the basic model requirements.

TABLE 16

```
‘‘‘json
{
  ″data_security_requirements″: {
    ″data_handling″: {
      ″secure_data_processing″: true,
      ″data_encryption_in_transit″: true,
      ″data_encryption_at_rest″: true
    },
    ″privacy_compliance″: {
      ″data_minimization″: true,
      ″personal_data_protection″: true,
      ″consent_management″: true
    }
  }
}
‘‘‘
```

Table 16 illustrates an example of requirements for data security verification among the basic security requirements.

TABLE 17

```
‘‘‘json
{
  ″performance_requirements″: {
    ″accuracy_metrics″: {
      ″minimum_accuracy″: ″90%″,
      ″minimum_f1_score″: ″0.85″,
      ″maximum_false_positive_rate″: ″1%″
    },
    ″robustness_metrics″: {
      ″required_tests″: [
        ″noise tolerance test″,
        ″outlier process test″,
        ″boundary value test″
      ],
      ″stability_requirements″: {
        ″drift_tolerance″: ″5%″,
        ″minimum_uptime″: ″99.9%″
      }
    }
  }
}
‘‘‘
```

Table 17 illustrates an example of requirements for accuracy and quality standards among the basic performance requirements.

TABLE 18

```
‘‘‘json
  ″scalability_requirements″: {
    ″concurrent_processing″: {
      ″minimum_concurrent_requests″: 100,
      ″request_queue_handling″: true
    },
    ″stability_criteria″: {
      ″minimum_mtbf″: ″720hours″,
      ″maximum_error_rate″: ″0.1%″,
      ″recovery_time_objective″: ″5minutes″
    }
  }
}
‘‘‘
```

Table 18 illustrates an example of requirements for scalability and stability among the basic performance requirements.

TABLE 19

```
‘‘‘json
{
  ″compatibility_requirements″: {
    ″platform_support″: {
      ″operating_systems″: [
        ″Android 10+″,
        ″iOS 14+″,
        ″HarmonyOS 2.0+″
      ],
      ″hardware_platforms″: [
        ″ARM64″,
        ″x86_64″
      ],
      ″accelerator_support″: [
        ″GPU″,
        ″NPU″,
        ″DSP″
      ]
    },
    ″api_compatibility″: {
      ″supported_api_versions″: [″1.0″, ″2.0″],
      ″backward_compatibility″: true,
      ″api_documentation″: true
    }
  }
}
‘‘‘
```

Table 19 illustrates an example for requirements for platform compatibility among basic compatibility requirements.

TABLE 20

```
‘‘‘json
{
  ″integration_requirements″: {
    ″deployment_compatibility″: {
      ″containerization_support″: true,
      ″orchestration_compatibility″: true
    },
    ″monitoring_integration″: {
      ″logging_support″: true,
      ″metrics_export″: true,
      ″tracing_capability″: true
    }
  }
}
‘‘‘
```

Table 20 illustrates an example of integration requirements of the basic compatibility requirements.

TABLE 21

```
‘‘‘json
{
  ″compliance_requirements″: {
    ″regulatory_compliance″: {
      ″gdpr_compliance″: true,
      ″ccpa_compliance″: true,
      ″hipaa_compliance″: true
    },
    ″certification_requirements″: {
      ″required_certifications″: [
        ″ISO 27001″,
        ″SOC 2″
      ]
    }
  }
}
‘‘‘
```

Table 21 illustrates an example of requirements for regulatory compliance among the legal/ethical compliance requirements.

TABLE 22

```
‘‘‘json
{
  ″ethical_requirements″: {
    ″fairness_criteria″: {
      ″bias_testing_required″: true,
      ″demographic_parity″: true,
      ″equal_opportunity″: true
    },
    ″transparency″: {
      ″model_explainability″: true,
      ″decision_traceability″: true,
      ″impact_assessment″: true
    },
    ″accountability″: {
      ″human_oversight″: true,
      ″audit_trails″: true,
      ″feedback mechanisms″: true
    }
  }
}
‘‘‘
```

Table 22 illustrates an example of ethical AI requirements among the legal/ethical compliance requirements.

The embodiments of the present invention may have the following advantages.

Advantages in System Architecture: The system has a modular structure based on micro verification agents, enabling easy addition of new verification items. It is designed with a plugin architecture that allows independent updating or replacement of verification agents, providing a flexible verification framework capable of handling various AI model types. The system can dynamically scale according to system load, offering excellent scalability and flexibility. Even if a verification agent fails, the overall system continues to operate, ensuring high availability. Critical data is secured through multiplexing and version management, while a caching system maintains fast responsiveness and system stability. Additionally, cross-verification of verification results may provide high reliability.

Advantages in Verification Process: The verification process may be performed quickly using parallel processing, and unnecessary re-verification may be minimized through incremental verification. Meta-verification is applied to improve the accuracy of verification results, and automated testing reduces the possibility of human errors. Verification covers multiple aspects such as performance, bias, security, and stability, and may perform comprehensive verification by combining static and dynamic analyses. Moreover, it offers specialized customized verification tailored to different execution environments and enables long-term quality assurance through continuous monitoring.

Advantages in Operation Management: The operation management allows immediate anomaly detection via real-time monitoring and efficient operation using an integrated dashboard. Automated reporting facilitates systematic quality management, and history management functions support traceability and audit responses. Superior features are provided for security and regulatory compliance. Strict access control and authorization management are implemented, and data encryption and secure protocols are applied to ensure safety. Also, it may systematically respond to regulatory requirements and implement a logging system that supports audit trails.

Advantages in User Experience: It may provide a developer-friendly environment that enables quick problem resolution through clear feedback, and the system may be easily utilized with an intuitive interface. Detailed guidelines and documentation are provided, and API-based automated verification integration is facilitated. In business values, it also has advantages. By providing verified AI models, it may enhance service reliability and shorten time-to-market through rapid verification and deployment. It reduces operational costs and improves resource efficiency while enhancing brand value through systematic quality management.

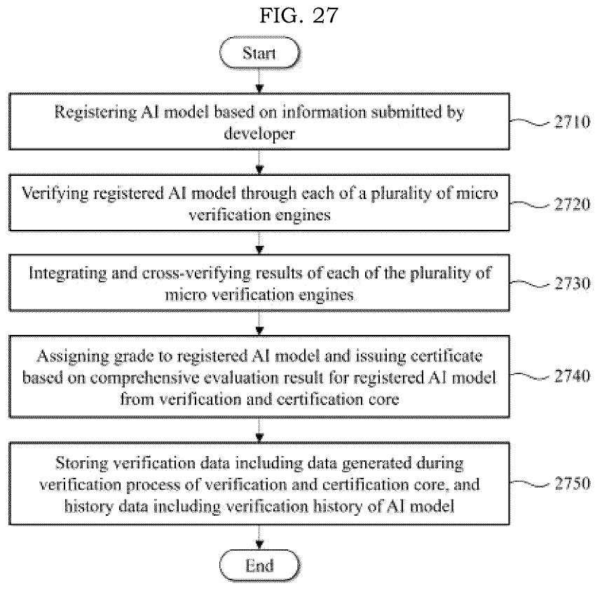

FIG. 27 is a flow chart illustrating an example of a method for verifying and certifying AI of the system for verifying and certifying AI according to an embodiment of the present invention. The Steps 2710 to 2750 included in the method for verifying and certifying AI of FIG. 27 may be implemented through the aforementioned system for verifying and certifying AI 400. The system for verifying and certifying AI 400 may be implemented by at least one computer device. Here, the computer device may correspond to the computer device 200 described above with reference to FIG. 2. For example, the processor 220 of the computer device 200 may be implemented to execute control instructions in accordance with the code of an operating system or at least one computer program stored in the memory 210. Here, the processor 220 may control the system for verifying and certifying AI 400 to perform the Steps 2710 to 2750 included in the method of FIG. 27, according to the control instructions provided by the code stored in the computer device 200.

In Step 2710, the system for verifying and certifying AI 400 may register an AI model based on information submitted by a developer. This registration of the AI model may be performed through the input layer 410 included in the system for verifying and certifying AI 400. Additionally, based on the information submitted by the developer, the system for verifying and certifying AI 400 may verify required documents and metadata and determine whether the basic requirements of the AI model are satisfied.

In Step 2720, the system for verifying and certifying AI 400 may verify the registered AI model through each of a plurality of micro verification engines. For example, the plurality of micro verification engines may include a first verification engine for performance verification (e.g., the above-described performance verification agent), a second verification engine for bias verification (e.g., the above-described bias verification agent), a third verification engine for security verification (e.g., the above-described security verification agent), and a fourth verification engine for stability verification (e.g., the above-described stability verification agent). These plurality of micro verification engines may correspond to the verification engine 421 included in the system for verifying and certifying AI 400.

At this time, the system for verifying and certifying AI 400, through the first verification engine, may measure at least one performance metric among response time, throughput, and accuracy related to the AI model, perform at least one test among a stress test and a load test for the AI model to evaluate system limits, and analyze the resource utilization efficiency of the AI model.

Also, the system for verifying and certifying AI 400, through the second verification engine, may verify the diversity and representativeness of the dataset used to train the AI model and analyze fairness in protected attributes to assess the presence of statistical bias in the AI model.

Moreover, the system for verifying and certifying AI 400, through the third verification engine, may conduct adversarial attack simulations for the AI model, examine possibility of data privacy breaches, and evaluate resistance for model reverse engineering to analyze security vulnerabilities.

Furthermore, the system for verifying and certifying AI 400, through the fourth verification engine, may verify operations for the AI model under boundary conditions, evaluate its ability to handle exceptional situations, and analyze whether performance degradation occurs during long-term operation.

In Step 2730, the system for verifying and certifying AI 400 may integrate and cross-verify the verification results of each of the plurality of micro verification engines. This integration and cross-verification of the verification results may be performed through the meta verification system 422 and the verification protocol 423 included in the system for verifying and certifying AI 400. For example, the system for verifying and certifying AI 400 may coordinate the execution of the plurality of micro verification engines to cross-analyze the mutual verification results between the plurality of micro verification engines. Additionally, the system for verifying and certifying AI 400 may verify the conformity of results among the plurality of micro verification engines, and in the case of conflicting verification results, apply arbitration logic to derive the result with relatively higher reliability, and score the reliability of the verification results. Also, the system for verifying and certifying AI 400 may verify the consistency of the results of repeated verifications by each of the plurality of micro verification engines, and analyze the temporal stability of the verification results to determine whether consistent results are produced under the same conditions.

In Step 2740, the system for verifying and certifying AI 400 may assign a grade to the registered AI model and issue a certificate based on the comprehensive evaluation result for the registered AI model from the verification and certification core. At this time, the system for verifying and certifying AI 400 may generate at least one of improvement suggestions and recommendations for the AI model based on the comprehensive evaluation result, and provide the same to the developer.

In Step 2750, the system for verifying and certifying AI 400 may store verification data including data generated during the verification process of the verification and certification core, and history data including the verification history of the AI model. This verification data and history data may be stored in a data storage (e.g., the data storage 440) included in the system for verifying and certifying AI 400. Also, the data storage may further store a knowledge base that includes verification criteria and reference data.

As such, according to the embodiments of the present invention, a method and system for verifying and certifying mobile AI based on a micro agent may be provided.

The aforementioned system and device may be implemented as a hardware component, a software component, and/or a combination of a hardware component and a software component. For example, the device and component described in the embodiments may be implemented using one or more general-purpose computers or special-purpose computers, such as a processor, a controller, an arithmetic logic unit (ALU), a digital signal processor, a microcomputer, a field programmable gate array (FPGA), a programmable logic unit (PLU), a microprocessor, or any other device capable of executing or responding to an instruction. The processing device may perform an operating system (OS) and one or more software applications that are executed on the OS. Furthermore, the processing device may access, store, manipulate, process, and generate data in response to the execution of software. For convenience of understanding, one processing device has been illustrated as being used, but a person having ordinary knowledge in the art may understand that the processing device may include a plurality of processing elements and/or a plurality of types of processing elements. For example, the processing device may include a plurality of processors or one processor and one controller. Furthermore, another processing configuration, such as a parallel processor, is also possible.

Software may include a computer program, a code, an instruction or a combination of one or more of them, and may configure a processing device so that the processing device operates as desired or may instruct the processing devices independently or collectively. The software and/or the data may be embodied in any type of machine, a component, a physical device, virtual equipment, or a computer storage medium or device in order to be interpreted by the processing device or to provide an instruction or data to the processing device. The software may be distributed to computer systems that are connected over a network, and may be stored or executed in a distributed manner. The software and the data may be stored in one or more computer-readable recording media.

The method according to an embodiment may be implemented in the form of a program instruction executable by various computer means and stored in a computer-readable medium. The computer-readable recording medium may include a program instruction, a data file, and a data structure solely or in combination. The medium may continue to store a program executable by a computer or may temporarily store the program for execution or download. Furthermore, the medium may be various recording means or storage means of a form in which one or a plurality of pieces of hardware has been combined. The medium is not limited to a medium directly connected to a computer system, but may be one distributed over a network. Examples of the medium may be magnetic media such as a hard disk, a floppy disk and a magnetic tape, optical media such as a CD-ROM and a DVD, magneto-optical media such as a floptical disk, and media configured to store program instructions, including, a ROM, a RAM, and a flash memory. Furthermore, other examples of the medium may include an app store in which apps are distributed, a site in which various pieces of other software are supplied or distributed, and recording media and/or storage media managed in a server. Examples of program instructions include both machine code, such as produced by a compiler, and higher level code that may be executed by the computer using an interpreter.

As described above, although the embodiments have been described in connection with the limited embodiments and the drawings, those skilled in the art may modify and change the embodiments in various ways from the description. For example, proper results may be achieved although the aforementioned descriptions are performed in order different from that of the described method and/or the aforementioned components, such as a system, a structure, a device, and a circuit, are coupled or combined in a form different from that of the described method or replaced or substituted with other components or equivalents thereof.

Accordingly, other implementations, other embodiments, and the equivalents of the claims fall within the scope of the claims.

1. A system for verifying and certifying artificial intelligence implemented by at least one computer device, the system comprising:
at least one processor; and at least one memory storing instructions that, when executed by the at least one processor, cause the at least one processor to implement:
an input layer for registering an artificial intelligence model based on information submitted by a developer;
a verification and certification core for verifying the registered artificial intelligence model through each of a plurality of micro verification engines, and integrating and cross-verifying verification results from the each of the plurality of micro verification engines;
an output layer for assigning a grade to the registered artificial intelligence model and issuing a certificate based on comprehensive evaluation result of the verification and certification core for the registered artificial intelligence model; and
a data storage for storing verification data including data generated during a verification process by the verification and certification core, history data including a verification history of the artificial intelligence model, and a knowledge base including verification criteria and reference data,
wherein the verification and certification core is configured to perform cross-analysis for mutual verification results among the plurality of micro verification engines by coordinating execution of the plurality of micro verification engines, wherein the performing the cross-analysis comprises:
verifying consistency among verification results from the plurality of micro verification engines by analyzing correlations between the verification results;
identifying conflicting verification results determined to represent anomaly patterns among the verification results from the plurality of micro verification engines based on the verification of consistency; and
applying an arbitration logic that calculates a composite score by applying reliability-based weights to the verification results from the plurality of micro verification engines based on the identification of the conflicting verification results and a result of the verification of consistency, and
wherein the verification and certification core is further configured to
check an existing verification history and a cache to determine a verification scope upon submission of the information for registering the artificial intelligence model, and
establish an optimized verification plan based on changed components in response that an incremental update of the artificial intelligence model is identified, to control operations of the plurality of micro verification engines.

2. The system for verifying and certifying artificial intelligence of claim 1, wherein the plurality of micro verification engines is configured to comprise a first verification engine for performance verification, a second verification engine for bias verification, a third verification engine for security verification, and a fourth verification engine for stability verification.

3. The system for verifying and certifying artificial intelligence of claim 2, wherein the first verification engine is configured to measure at least one performance metric among response time, throughput, and accuracy in relation to the artificial intelligence model, to perform at least one of a stress test and a load test on the artificial intelligence model to evaluate the system's limitations, and to analyze resource utilization efficiency of the artificial intelligence model.

4. The system for verifying and certifying artificial intelligence of claim 2, wherein the second verification engine is configured to verify diversity and representativeness of dataset used for training the artificial intelligence model, and to evaluate presence of statistical bias in the artificial intelligence model by analyzing fairness with respect to protected attributes.

5. The system for verifying and certifying artificial intelligence of claim 2, wherein the third verification engine is configured to perform adversarial attack simulations on the artificial intelligence model, to examine possibility of data privacy breaches, and to evaluate resistance for model reverse engineering to analyze security vulnerabilities.

6. The system for verifying and certifying artificial intelligence of claim 2, wherein the fourth verification engine is configured to verify operations for the artificial intelligence model under boundary conditions, to evaluate its ability to handle exceptional situations, and to analyze whether performance degradation occurs during long-term operation.

7. (canceled)

8. (canceled)

9. The system for verifying and certifying artificial intelligence of claim 1, wherein the verification and certification core is configured to verify consistency of the results obtained from repeated verifications performed by each of the plurality of micro verification engines, and to determine whether consistent results are derived under identical conditions by analyzing the temporal stability of the verification results.

10. The system for verifying and certifying artificial intelligence of claim 1, wherein the output layer is configured to generate at least one of improvement suggestions and recommendations for the artificial intelligence model based on the comprehensive evaluation results based on the composite score, and to provide the same to the developer.

11. The system for verifying and certifying artificial intelligence of claim 1, wherein the input layer is configured to verify required documents and metadata through information submitted by the developer, and to determine whether basic requirements of the artificial intelligence model are satisfied.

12. A method for verifying and certifying artificial intelligence of a system for verifying and certifying artificial intelligence implemented by at least one computer device, wherein the at least one computer device comprises at least one processor, and
the method for verifying and certifying artificial intelligence comprising:
registering an artificial intelligence model based on information submitted by a developer, by the at least one processor;
verifying the registered artificial intelligence model through each of a plurality of micro verification engines, by the at least one processor;
integrating and cross-verifying verification results from the each of the plurality of micro verification engines, by the at least one processor;
assigning a grade to the registered artificial intelligence model and issuing a certificate based on comprehensive evaluation result of the verification and certification core for the registered artificial intelligence model, by the at least one processor; and
storing verification data including data generated during a verification process by the verification and certification core and history data including a verification history of the artificial intelligence model, by the at least one processor,
wherein the integrating and cross-verifying verification results comprises:
performing cross-analysis for mutual verification results among the plurality of micro verification engines by coordinating execution of the plurality of micro verification engines,
wherein the performing the cross-analysis comprises:
verifying consistency among verification results from the plurality of micro verification engines by analyzing correlations between the verification results;
identifying conflicting verification results determined to represent anomaly patterns among the verification results from the plurality of micro verification engines based on the verification of consistency; and
applying an arbitration logic that calculates a composite score by applying reliability-based weights to the verification results from the plurality of micro verification engines based on the identification of the conflicting verification results and a result of the verification of consistency,
wherein the method further comprises:
checking an existing verification history and a cache to determine a verification scope upon submission of the information for registering the artificial intelligence model, and
establishing an optimized verification plan based on changed components in response that an incremental update of the artificial intelligence model is identified, and
wherein operations of the plurality of micro verification engines are controlled in accordance with the optimized verification plan.

13. The method for verifying and certifying artificial intelligence of claim 12, wherein the plurality of micro verification engines is configured to comprise a first verification engine for performance verification, a second verification engine for bias verification, a third verification engine for security verification, and a fourth verification engine for stability verification.

14. The method for verifying and certifying artificial intelligence of claim 13, wherein the verifying the registered artificial intelligence model is configured to, through the first verification engine, measure at least one performance metric among response time, throughput, and accuracy in relation to the artificial intelligence model, to perform at least one of a stress test and a load test on the artificial intelligence model to evaluate the system's limitations, and to analyze resource utilization efficiency of the artificial intelligence model.

15. The method for verifying and certifying artificial intelligence of claim 13, wherein the verifying the registered artificial intelligence model is configured to, through the second verification engine, verify diversity and representativeness of dataset used for training the artificial intelligence model, and to evaluate presence of statistical bias in the artificial intelligence model by analyzing fairness with respect to protected attributes.

16. The method for verifying and certifying artificial intelligence of claim 13, wherein the verifying the registered artificial intelligence model is configured to, through the third verification engine, perform adversarial attack simulations on the artificial intelligence model, to examine possibility of data privacy breaches, and to evaluate resistance for model reverse engineering to analyze security vulnerabilities.

17. The method for verifying and certifying artificial intelligence of claim 13, wherein the verifying the registered artificial intelligence model is configured to, through the fourth verification engine, verify operations for the artificial intelligence model under boundary conditions, to evaluate its ability to handle exceptional situations, and to analyze whether performance degradation occurs during long-term operation.

18. (canceled)

19. A non-transitory computer-readable recording medium having recorded thereon a computer program for executing the method according to claim 12 on a computer device.
